(19) United States
(12) Patent Application Publication
(10) Pub. No.: US 2011/0215571 A1
(43) Pub. Date: Sep. 8, 2011

(54) Coupling component for a fluidic quick-connection system

(75) Inventor: Eberhardt Nonnenmacher, Ingersheim (DE)

(73) Assignee: DUERR DENTAL AG, Bietigeim-Bissingen (DE)

(21) Appl. No.: 13/023,259

(22) Filed: Feb. 8, 2011

(30) Foreign Application Priority Data
Mar. 4, 2010 (DE) 20 2010 003 186.9

(51) Int. Cl. F16L 19/00

(52) U.S. Cl. 285/345

(57) ABSTRACT

For the purpose of attaching a flush end portion of a pipe to a quick-coupling system it is proposed to equip a coupling component, which is provided with a coupling head, with a connecting portion which is capable of being firmly connected to the outside of the end portion of the pipe, for example using a fixing screw.

### CROSS REFERENCE TO RELATED APPLICATIONS

This application claims the filing benefit of German Patent Application No. 20 2010 003 186.9 filed Mar. 4, 2010 the contents of which are incorporated herein by reference.

### FIELD OF THE INVENTION

The invention relates to a coupling component of a fluidic quick-connection system.

### BACKGROUND OF THE INVENTION

A quick-connection system of such a type is described in German utility model DE 297 18 150.

With the quick-connection system described therein it is possible for pipe connections with complicated geometry consisting of straight lengths of pipe and angle elements to be constructed. In this case there is also provision to connect the end of flush pipe portions to special coupling components which then enable the pipe to be continued using elements of the quick-connection system. This is effected by a tubular connecting portion of a coupling component being introduced into the interior of the flush pipe component to be attached.

In this manner a flow connection can be established that is impervious but that does not withstand any strong forces.

The present invention is directed to resolving these and other matters.

### SUMMARY OF THE INVENTION

By virtue of the present invention a coupling component is to be developed further in such a way that it can be connected to a length of pipe so as also to be capable of bearing great mechanical loads.

In accordance with the invention this object is achieved by a coupling component which exhibits at one end a coupling head of a quick coupling, wherein a connecting portion which, with close fit, is capable of being pushed over an end portion of a pipe , and by means for fixing the connecting portion on the end portion of the pipe.

Since the coupling component according to the invention co-operates with the external surface of the length of pipe to be attached, there is a good access here which permits the joint to be configured in such a way that it is able to withstand large mechanical forces.

In an embodiment of the invention, the joint a fixing collar, for example, may be provided which is slotted and capable of sliding over the length of pipe when the tightening screw is released, whereupon the tightening screw is then tightened in order to press the spring arms of the fixing collar firmly against the external surface of the pipe. At the joint a fixing screw may also be provided which acts directly in a transverse thread of the coupling component and co-operates in clamping manner with the external surface of the length of pipe or works itself into the external surface of the length of pipe. An adhesive layer may also be provided at the joint.

None of these connection options can be implemented if the connecting portion of the coupling component co-operates with the internal surface of the length of pipe to be attached.

Another embodiment of the invention permits two normal lengths of pipe to be joined together. In the case of a straight bridge piece an aligned straight connection is obtained; in the case of an angled bridge piece, a corner joint.

Another embodiment of the invention is advantageous with regard to an exactly predetermined spacing of the ends of lengths of pipe to be connected.

Another embodiment of the invention is advantageous with regard to a good sealing of the joint.

With another embodiment of the invention an axial interlocking of the two coupling components is obtained when the plug-in connection is closed. The quick connection consequently remains reliably impervious also when axial tensile forces are exerted.

In the case of a coupling component according to another embodiment of the invention, the locking is effected in a manner that is symmetrical with respect to the axis of the coupling component. Hence tilting moments are kept away from the quick connection by the locking device.

Another embodiment of the invention is advantageous with regard to a simple securing of the locking component on the coupling component.

Another embodiment of the invention is advantageous with regard to, if necessary, a simple removal of the locking component.

With another embodiment of the invention a particularly precise positioning of the locking component is obtained.

Another embodiment of the invention is advantageous with regard to an easy latching and detachment of the locking component but, in addition, ensures particularly good positive engagement between the locking arms of the locking component and the locking groove.

On the basis of the coupling component according to the invention it is also possible for rigid pipeline elements to be produced which are easily assembled by being put together so as to form conduits of desired geometry.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

FIG. 1 is an axial section through a quick-connection system acting between two straight pipe ends.

FIG. 2 is a transverse section through the joint along section line B-B in FIG. 1.

FIG. 3 is a top view of the joint shown in FIG. 1 on a smaller scale.

FIG. 4 depicts the use of components of a quick-connection system for attaching a hose to a flush pipe.

FIG. 5 is a transverse section through the joint according to FIG. 4 along section line B-B therein.

FIG. 6 is a top view of the joint according to FIG. 4 on a reduced scale.

### DETAILED DESCRIPTION OF THE DRAWINGS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

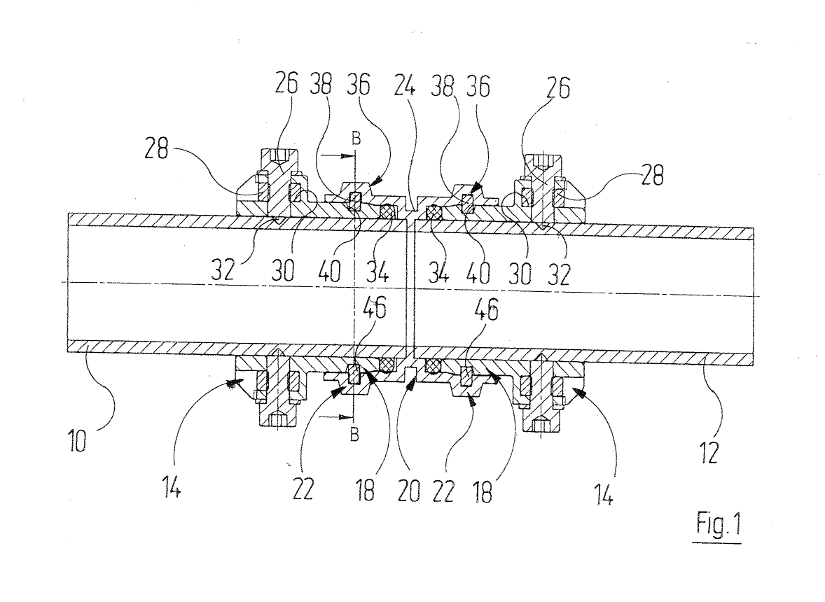

In FIG. 1 two end portions of straight round pipes are denoted by 10 and 12. On these end portions there is seated in each instance a coupling component 14 which exhibits a tubular connecting portion 16, co-operating with the external surface of an end portion 10, 12, and a coupling head 18 to be described still more precisely below.

The two coupling components 14 are connected by a bridge component 20 which exhibits two counter-coupling heads 22 which are complementary to the coupling heads 18.

The bridge component 20 has a drawn-inward central portion 24 which in a radial section plane exhibits the shape of a rectangular U. The internal surface of portion 24 fits, subject to close clearance, over the external surfaces of the end portions 10, 12.

In the connecting portions 16 of the coupling components 14 in each instance two diametrically opposing fixing screws 26 are provided which act in a nut 28 which is inserted in a recess 30 of the coupling component 14. The fixing screws 26 each have a conical tip 32 which is able to work itself into the material of an end portion 10, 12.

The inside diameter of the coupling component 14 is chosen so that the coupling component can be pushed, subject to close clearance, onto the external surface of an end portion 10, 12. After tightening of the fixing screw 26, the end portion of the pipe has then been given the capability to co-operate with the bridge component 20 or with another element of the quick-connection system.

The position of the coupling component 14 on the end portion 10 or 12 of the pipe is chosen so that the free front face of the coupling component 14 is remote from the front face of the corresponding end portion 10, 12 of the pipe by a predetermined distance. More precisely, this distance is chosen so that an O-ring seal 34, which is situated between the opposing front faces of portion 24 of the bridge component 20 and the free front face of the coupling component 14, is given a predetermined initial tension in the axial and radial directions.

In order to be able to maintain this initial tension, in each instance a locking unit denoted overall by 36 acts between the bridge component 20 and the coupling components 14.

In the portions of the bridge component 20 that are exterior in FIG. 1 in each instance a locking groove 38 is provided, and in each instance a positioning groove 40 is moulded in the external surface of the coupling head 18 of the coupling components 14.

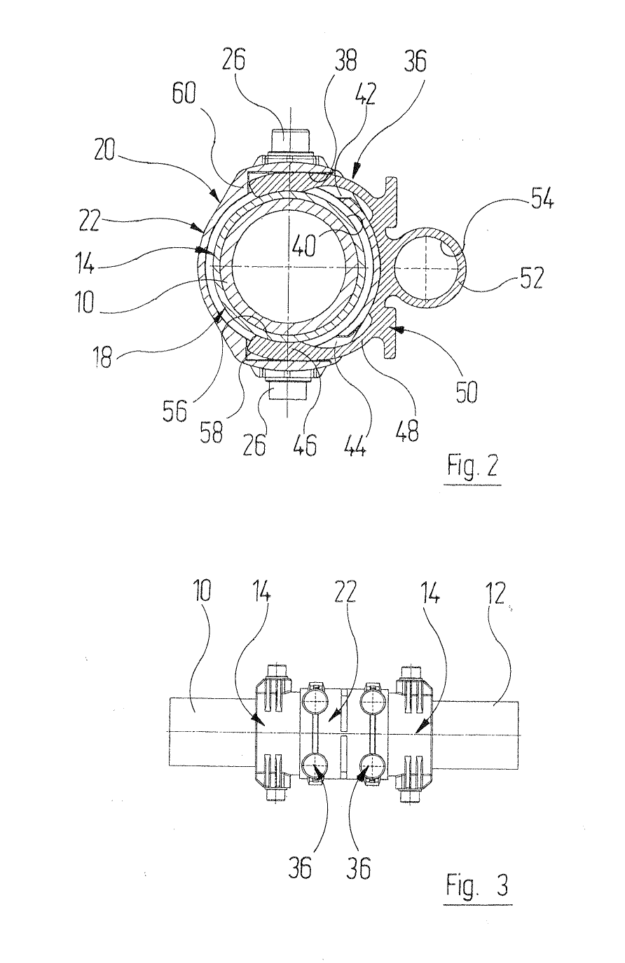

Said positioning groove is connected via two opposing windows 42 to the interior space of the coupling component, as is evident in particular from FIG. 2.

In the region of the windows 42 two guide tabs 44 are moulded onto the outside of the coupling component 14.

Into the windows 42 there are introduced, from the right in FIG. 2, two diametrically opposing locking arms 46 which have been assembled with the aid of interposed flexural portions 48 so as to form a locking component denoted overall by 50.

In its centre the locking component 50 has a gripping portion 52 which is provided with an aperture 54. On the latter a tool for pulling the locking component 50 can be fitted.

As is clearly evident from FIG. 2, the internal surfaces of lateral shanks of the guide tabs 44 accommodate the front face of the locking arms 46 between themselves. Hence the locking arms 46 are axially fixed both in their radially interior portion (by the walls of the locking groove 36) and in their radially exterior portion (by the shanks of the guide tabs 44) and consequently do not tilt onto the quick connection, even when large tensile forces are exerted, although the locking arms are elastically radially mobile and the flexural portions 48 bearing them have to exhibit smaller cross-section and are therefore capable of twisting somewhat.

Hence the coupling components 14 and the bridge component 20 are capable of being connected and disconnected simply and rapidly, and at the same time the quick connection also withstands great axial loads.

As evident from FIG. 2, the windows 42 together with the guide tabs 44 can be produced in the course of injection moulding by a corresponding two-armed slide being introduced into the injection mould from the side.

As likewise evident from FIG. 2, the locking arms 46 have a radially interior boundary surface 56, the diameter of curvature of which corresponds to the outside diameter of the connecting portion 16. An exterior boundary surface 58 of the locking arms 46 runs substantially in accordance with the outside diameter of the connecting portion 16 and spaced from the internal surface of the guide tabs 44, so that the locking arms 46 are able to spring radially outwards, with elastic deformation of the flexural portions 48, when the locking component 50 in FIG. 2 is drawn to the right out of the bridge component 20 and out of the coupling component.

In its portion situated on the left in FIG. 2 the locking groove 38 has in each instance a stop shoulder 60 which together with the end face of an assigned locking arm 46 constitutes a stop acting in the direction of insertion.

The coupling component 14 and the bridge component 20 are integral plastic injection-moulded components which, for example, may be fibre-filled thermosetting plastics. The locking component 50 is also a plastic injection-moulded component. But for the locking component use is preferentially made of a thermoplastic having good springing capacity.

In the drawing the pipe connection is shown in the closed state. In order to open the connection, the locking component 50 in FIG. 2 is drawn out of the windows 42 to the right. Hence the axial lock between the coupling component 14 and the bridge component 20 is removed, and, by overcoming the friction force generated by the compressed O-ring seal 34 on the internal surface of the connecting portion 16, the coupling component 14 and the bridge component 20 can be pulled apart in the axial direction.

Closing of the coupling described above is effected in the converse direction to opening: firstly the bridge component 20 is pushed over the coupling component 14 until the front face of the coupling component 14 strikes the portion 24 of the bridge component 20 via the O-ring seal. In this position the locking groove 38 is then aligned with the positioning groove 40 and with the windows 42 provided in the connecting portion 16. The locking component 50 can now be pushed, subject to elastic widening, into the windows 42 and into the locking groove 38, whereby with the bent boundary surfaces of the locking arms 46 it latches on the bottom of the locking groove 38. Since the thickness of the locking component 50 corresponds to the width of the locking groove 38, the bridge component 20 and the coupling component 14 are now locked in the axial direction in clearance-free manner.

The connecting of the bridge component 20 to the coupling component 14 situated on the right in FIG. 1 is effected similarly, whereupon a flow-medium-impervious connection between the end portions 10, 12 of the pipe is then established.

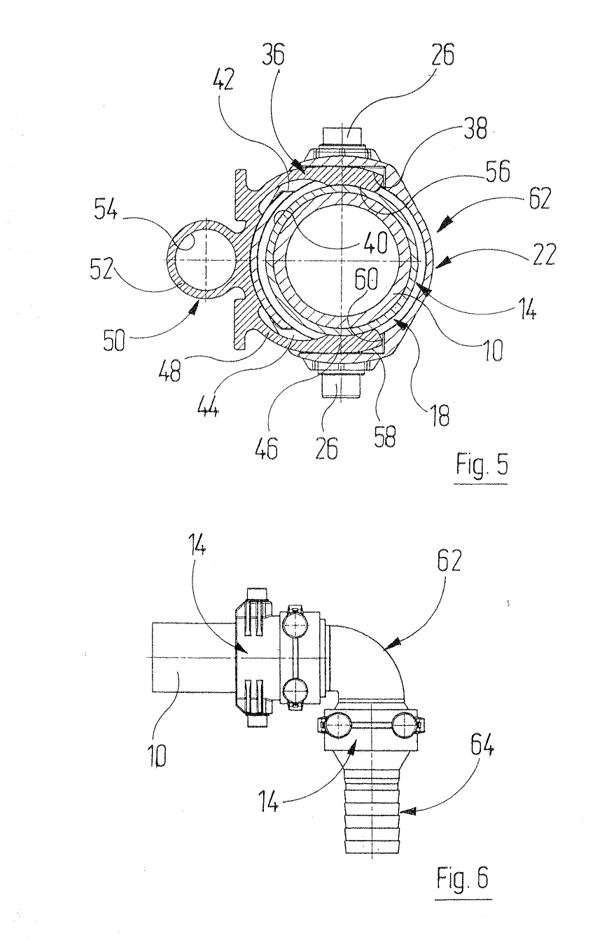

FIGS. 3 to 5 show a modified embodiment of the invention.

Onto an end portion 10 of the pipe a coupling component 10 is again firmly attached using fixing screws 26, whereby the front face of the coupling head 18 again maintains the aforementioned spacing from the annular end face of the end portion 10 of the pipe.

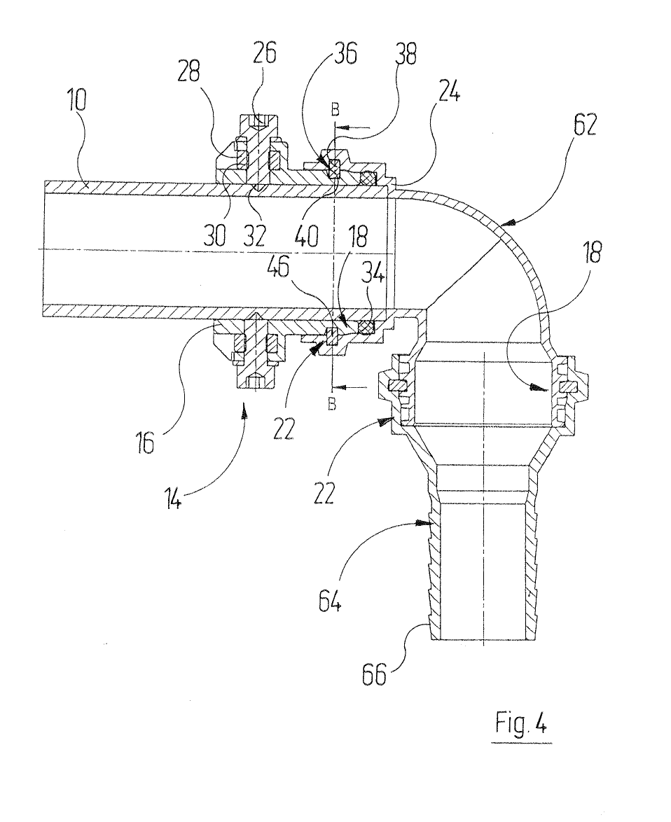

But the coupling head 18 of the coupling component 14 is now connected to a counter-coupling head 22 which is part of a pipe elbow 62. The latter is an integral injection moulding and is provided at its second end with a coupling head 18. Onto the end of the pipe elbow 66 a hose coupling 64 is fitted which is provided at one end with ribs 66 for fixing a hose, and at the end situated at the top in FIG. 4 is provided with a counter-coupling head 22 which is connected to coupling head 18 of the pipe elbow 62.

Instead of the hose coupling 64, in further development of the invention other pipe-system components could also be attached which in each instance exhibit at one end a coupling head 18 and at the other end a counter-coupling head 22. Accordingly in this way a pipe constructed from system components, consisting of several segments, can then be connected to a flush standard pipe.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A coupling component for a fluidic quick-coupling system, comprising:
at one end a coupling head of a quick coupling,
wherein a connecting portion which, with a close fit, is capable of being pushed over an end portion of a pipe, and by means for fixing the connecting portion on the end portion of the pipe.

2. The coupling component of claim 1, wherein the fixing means include a fixing collar, a fixing screw or a layer of adhesive.

3. The coupling component of claim 1, further comprising: a bridge component which is provided at both ends with counter-coupling heads.

4. The coupling component of claim 3, wherein the bridge component includes a drawn-inward portion which overlaps a front face of the end portion of the pipe.

5. The coupling component of claim 3, wherein the counter-coupling heads of the bridge component include a radial shoulder which is situated opposite a radial shoulder of the coupling head, and between these two shoulders a seal is situated which is clamped between the shoulders.

6. The coupling component of claim 1, wherein the coupling head includes a locking groove into which there engages a locking component, supported on a counter-coupling head, which includes a thickness corresponding to a width of a locking groove.

7. The coupling component of claim 6, wherein the locking component includes two locking arms which engage the locking groove at diametrically opposing places.

8. The coupling component of claim 7, wherein the two locking arms are each borne by a flexural portion of the locking component.

9. The coupling component of claim 8, wherein the locking component includes a gripping portion pointing outward.

10. The coupling component of claim 8, wherein the locking arms are guided in passageways of the counter-coupling heads.

11. The coupling component of claim 7, wherein radially interior boundary surfaces of the locking arms have a curvature corresponding to a curvature bottom of the locking groove, so that the locking arms are capable of latching onto a curved bottom of a positioning groove.
